(19) United States
(12) Patent Application Publication
(10) Pub. No.: US 2020/0000138 A1
(43) Pub. Date: Jan. 2, 2020

(54) Corn Preparation System

(71) Applicant: Lowell Crawford, Davie, FL (US)

(72) Inventor: Lowell Crawford, Davie, FL (US)

(21) Appl. No.: 16/024,044

(22) Filed: Jun. 29, 2018

(51) Int. Cl. A23N 12/10

(52) U.S. Cl. CPC A23N 12/10; A47J 37/041

(57) ABSTRACT

The present invention discloses a system for providing roasted corn to a consumer. The system includes a venue having at least one boiling assembly, at least one roasting assembly, at least one storage component, and at least one deep-frying assembly. A user performs the steps of parboiling an ear of corn followed by roasting the ear of corn. A flavoring agent is applied to the ear of corn before it is provided to the consumer.

### TECHNICAL FIELD

The present invention generally relates to cooking, and more specifically, relates to a system and method for providing seasoned and roasted corn at a food venue including but not be limited to Malls, Kiosks, In-Line Stores, Carts, Air Ports, Sport Arenas, Festivals and any such gathering that would attract large groups of potential consumers BACKGROUND

Corn has long been the most cultivated grain in the world. In 2014 alone, the total world production was 1.04 billion metric tons, led by the United States. While corn is the backbone of a variety of industries, namely biofuels, livestock feed, and chemical production, the grain also finds its way to human consumption and is considered a staple food.

When distributed for human consumption, corn is often delivered to a processing plant or direct-to-consumer on the cob. While some prefer to remove the kernels from the cob before consumption, many prefer to eat the corn directly from the cob. It is well known to cook such corn cobs by boiling them to a more edible and desirable form. In doing so, much of the inherent flavor and nutrients are lost. To preserve these characteristics, parboiling techniques are used first to soften the corn, followed by finishing the corn using various other forms of cooking.

U.S. Pat. No. 4,920,872 to Peter M. J. Henry disclosed a method of cooking corn on the cob wherein the corn is partially cooked in a parboiling assembly, removed, and then roasted, grilled or broiled on a roasting assembly. The roasting assembly comprises a heat source adjacent a gridiron composed of substantially parallel elongate cylindrical elements. These elements are spaced apart to support a corn cob between the or each pair of neighboring elements and are mounted for rotation to rotate the corn cob or cobs thereon. The parboiling assembly and the roasting assembly are parts of the same apparatus which, in one preferred form, is mounted on wheels to render it easily movable, under human power, between locations where freshly roasted corn is to be made or served, e.g., to be offered for sale. While the '872 patent discloses the techniques of parboiling, it leaves out critical inventive components related to the finishing of the corn before consumption.

It can be seen that an improvement in the arts related to corn preparation methods is needed. One such improvement is described in the various embodiments presented herein.

### SUMMARY OF THE INVENTION

This summary is provided to introduce a variety of concepts in a simplified form that is further disclosed in the detailed description of the invention. This summary is not intended to identify key or essential inventive concepts of the claimed subject matter, nor is it intended for determining the scope of the claimed subject matter.

In one embodiment, a system for providing roasted corn includes a venue having an interior region. The interior region is accessible to a plurality of providers associated with the venue. A surface permits the placement of at least one boiling assembly, at least one roasting assembly, at least one storage component, and at least one deep-frying assembly. During preparation, at least one provider performs the steps of parboiling an ear of corn for a predetermined time interval. Next, the corn is roasted at a second predetermined time interval and a predetermined temperature. Following roasting, the corn is provided with at least one flavoring agents before being given to the consumer.

In another embodiment, following the addition of the flavoring agents, the corn is battered and deep-fried for a pre-determined time interval at a pre-determined frying temperature before the corn is provided to the consumer.

In an embodiment, the system has a sink assembly comprised of a water source, a plurality of sink basins, a water heater, and a water pump to propel water from the water source to the sink basins. The water source can be in fluid communication with the boiler assembly. In a further embodiment, the sink basins are in fluid communication with a grey water tank wherein waste is stored.

In yet another embodiment, an interactive menu is provided to permit consumers to engage therewith. The menu transmits a plurality of options to the consumer such that the consumer selects from the plurality of options. Each selection is transmitted to the provider. The menu may also be provided as a point-of-sale system to receive payment from the consumer. A controller is in communication with each preparation component in addition to a sensor system, a timer system, and an alert system. The sensor system is configured to sense the temperature of each preparation component and provide an alert, via an alert system, if any component is at a temperature not within a predetermined temperature range. Similarly, the timing system sends a signal to the alert system at or near the pre-determined time interval at each step of the preparation process. An interface permits the user to input settings related to each sensor within the system.

It is a goal of the present invention to provide suitably prepared corn in a variety of flavors. Further, in a preferred embodiment, the venue is a self-contained and partially mobile.

Moreover, in accordance with a preferred embodiment of the present invention, other aspects, advantages, and novel features of the present invention will become apparent from the following detailed description in conjunction with the drawings.

### BRIEF DESCRIPTION OF THE DRAWINGS

A more complete understanding of the present invention, and the advantages and features thereof, will be more readily understood by reference to the following detailed description when considered in conjunction with the accompanying drawings wherein:

FIG. 1 illustrates a perspective view of the venue used in the preparation of corn, according to an embodiment of the present invention;

FIG. 2 illustrates a perspective view of the venue used in the preparation of corn, according to an embodiment of the present invention;

FIG. 3 illustrates a flowchart of a method for providing prepared an ear of corn to a consumer, according to an embodiment of the present invention;

FIG. 4 illustrates a schematic of the self-contained sink assembly; according to an embodiment of the present invention; and

FIG. 5 illustrates a block diagram of the network components; according to an embodiment of the present invention.

### DETAILED DESCRIPTION

The specific details of the single embodiment or variety of embodiments described herein are to the described system and methods of use. Any specific details of the embodiments are used for demonstration purposes only and not unnecessary limitations or inferences are to be understood therefrom.

Any reference to “invention” within this document is a reference to an embodiment of a family of inventions, with no single embodiment including features that are necessarily included in all embodiments, unless otherwise stated. Furthermore, although there may be references to “advantage's” provided by some embodiments, other embodiments may not include those same advantages, or may include different advantages. Any advantages described herein are not to be construed as limiting to any of the claims.

Before describing in detail exemplary embodiments, it is noted that the embodiments reside primarily in combinations of components related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second” and the like, may be used solely to distinguish one entity or element from another entity or element without necessarily requiring or implying any physical or logical relationship or order between such entities or elements.

In general, the embodiments described herein relate to a system and method for providing prepared corn to a consumer. The system is comprised of a venue where consumers can interact with a menu to select from a list of options thereon. Once the user has selected their consumable item, providers associated with the venue prepare the corn according to the novel method provided herein. As used herein, the term “user” may refer to the provider or the consumer who receives the prepared corn.

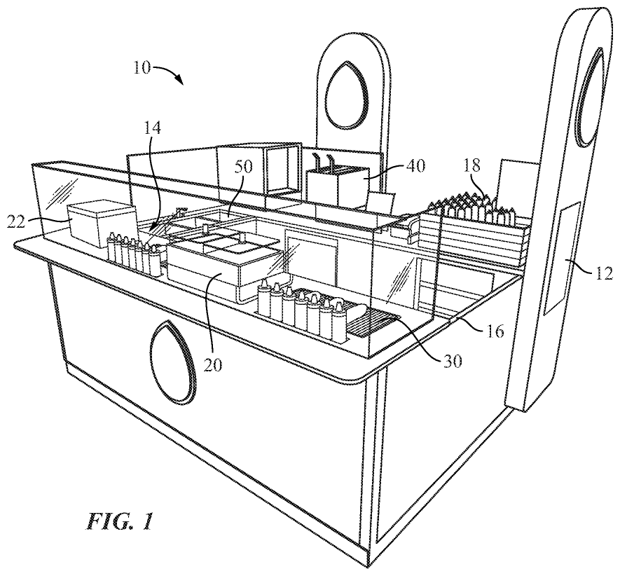

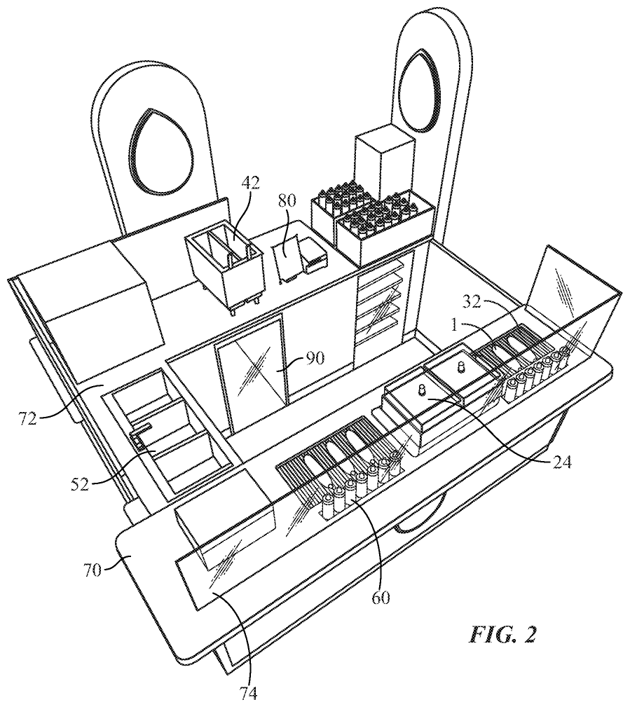

FIG. 1 and FIG. 2 illustrate an exemplary embodiment of the system for providing prepared ears of corn 1 to a consumer. The venue 10 has a variety of preparation components comprised of at least one boiler assembly 20, at least one roaster assembly 30, at least one seasoning station 60, and at least one deep-fryer assembly 40. Each preparation component of the venue 10 is provided within the interior region 14 wherein providers operate each preparation component and engage with consumers. The venue 10 can also include a door 16 to enclose the personnel and maintain safety within the workplace. Also provided, are a plurality of sink assemblies 50. At least one display component 22 can be presented in view of the consumer as a marketing or advertisement implement.

Ears of corn 1 are ideally shipped and stored at or below 45° F. to prevent spoilage and maintain freshness. For this reason, a storage component 18 is provided within the venue 10. The storage component 18 can be provided as a plurality of storage bins wherein ears of corn 1 and a refrigeration means are held. For the purpose of the description, the refrigeration means can include any device or item to cool an item, such as ice, refrigerators, freezers, or likewise devices. The storage bin can be partially filled with ice to ensure the corn stays fresh. A refrigeration unit 90 can be provided in addition to, or in place of the storage bins. Preferably, the ear of corn is pre-cooled to about 32° F. (e.g., using cold water) immediately after picking (or within 4 hours of picking) to reduce the corn's metabolism rate. It is also preferred to keep the ears cold (e.g., about 0-40° F.) throughout the shipping and display steps. The placement of the at least one ear in a shank down, vertical orientation prevents damage to the corn caused by the kernels abutting the packaging as seen in horizontally packaged corn where all the kernels on one side of the ear rest against the packaging.

In a preferred embodiment, the boiler assembly 20 is used as a parboiler. The parboiler is comprised of a heating element and a reservoir 24 to receive the ears of corn 1 during the parboiling process. The heating element can use any known means as a fuel source including electricity, gas, or organic combustible material.

The plurality of roaster assemblies 30 each include a heating element in communication with a heated gridiron surface 32. The gridiron 32 can be configured to rotate resulting in the spinning the ear of corn 1 throughout the roasting process. Further, the gridiron 32 can be configured as a moving track timed to transfer the corn 1 from a first end to a second end with a transfer time adjusted to span a pre-determined cooking/heating time interval. The roaster assembly 30 can utilize a dedicated heat source or a conventional heat source in communication with each heating element.

Flavoring agents 60 can include liquid basting seasonings, dry seasonings, and any seasoning blend commonly used in the arts. The application of seasoning can include first basting the ear of corn 1 in a fluid or semi-fluid mixture followed by the application of a dry seasoning onto the exterior of the ear of corn 1. The basting step is used to promote adherence of the dry seasoning onto the surface of the ear of corn 1. Each flavoring agent 60 can be set within a refrigerated portion to extend shelf life. It may be desired that specific flavor agents be heated before application. In this instance, the flavoring agent 60 is stored in a heated region.

In one embodiment, the venue 10 has a first surface 70 and a second surface 72. The first surface includes the parboiling reservoirs 24, gridirons 32, and flavoring agents 60. Consumers are protected from these components by a transparent barrier 74 positioned on the first surface. The second surface includes the storage component 18, deep-frying assembly 40, and at least one point-of-sale system 80.

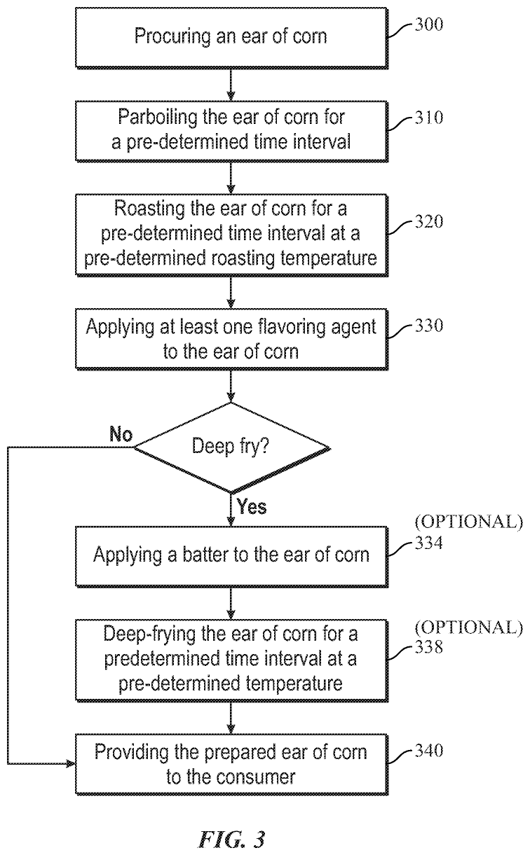

A method of providing prepared corn to a consumer is provided in FIG. 3. In step 300, at least one ear of corn is procured from the storage component. The ear of corn can be selected by the provider or by the consumer. The ear of corn is selected from an inventory which is preferably stored under refrigeration. Alternatively, ears of corn can be rotated into the display shortly before the process of preparation. Once selected, the corn is parboiled for a predetermined time interval in step 310. Parboiling can include the steps of filling the boiler assembly with water and seasoning the water to provide additional flavor to the ear of corn. Following parboiling, the ear of corn is transferred to the roasting assembly in step 320. The ear of corn is then roasted at a pre-determined temperature for a pre-determined time interval.

Once sufficiently roasted, the corn is provided with a flavoring agent in step 330. Via the menu, the consumer can select from a list of flavoring agents to be applied before consumption. In step 340, the prepared ear of corn is provided to the consumer. Optionally, the consumer can elect to have the flavored ear of corn deep-fried. If the consumer has elected the deep-fry option, the provider applies a batter to the exterior of the ear of corn (step 334) and deep-fries the corn for a predetermined time interval at a predetermined temperature in step 338.

Each ear of corn 1 can be presented to the preparation process in a variety of ways. In one example, the ear of corn 1 is partially shucked to expose the kernels to the boiling water, while leaving the husk attached at an end. The husk is then replaced before roasting to protect the kernels from direct contact with the gridiron 32. In another example, the corn 1 is wholly shucked to remove the husk and directly expose the kernels to each heating element. Of course, a variety of shucking methods are known in the arts. Each of which may be employed without deterring from the scope of the present invention.

In a preferred embodiment, the ears of corn are parboiled (step 310) for a time interval of 4-7 minutes depending on the size of the ear of corn and the desired texture. Following the 4-7 minute time interval, the ear of corn is roasted (step 320) at a temperature of at least 300° F. until a majority of the kernels on the ear of corn turn a golden brown color. It is understood that each consumer can have a differing preference for doneness. Differing preferences can be accounted for by modifying the length of time the ear of corn is roasted. During the roasting process, each ear of corn is rotated, either manually or automatically via a rotating gridiron.

In one embodiment, each ear of corn is provided with a handle before reaching the customer. The handle can be defined as the husk partially shucked away from the husk, or as a handle with a poker as known in the arts.

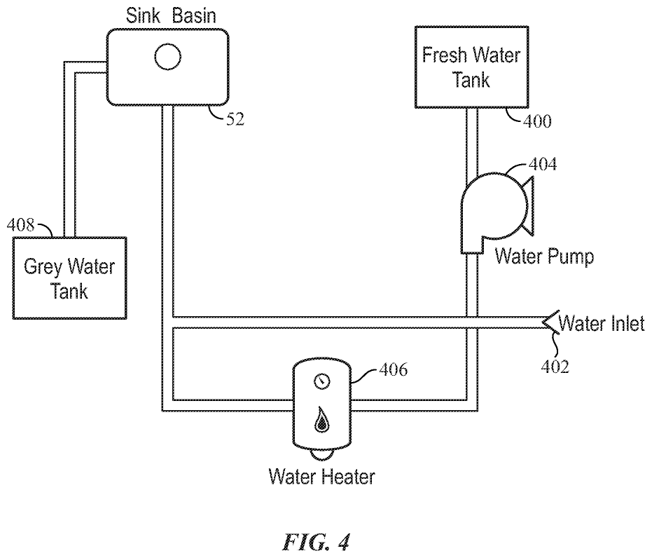

In reference to FIG. 4, the sink assembly 50 has a plurality of sink basins 52 in fluid communication with at least one water pump 404 and at least one electric water heater 406. The sink assembly 50 may be used to clean the venue 10, clean the corn 1 before boiling, or promote provider sanitation while in the working environment. In the preferred embodiment, the sink assembly is self-contained and portable. A freshwater tank 400 receives water from inlet 402 and stores water therein. The faucet allows for hot and/or cold water to be dispensed via a cold-water line and hot water line. Each sink basin 52 includes a drain in fluid communication with a grey water tank 408 wherein waste is stored.

While the preferred embodiment describes a self-contained and portable sink assembly 50, it is understood that a conventional sink system may be utilized without departing from the spirit of the invention.

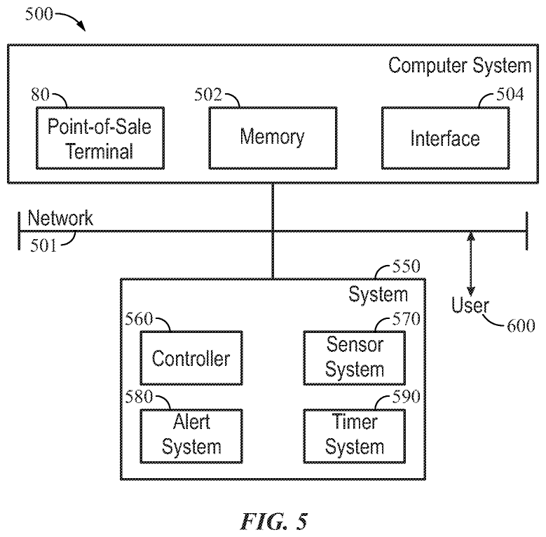

In reference to FIG. 5, a computer system 500 is illustrated in an exemplary embodiment. Prior to receiving their prepared ear of corn 1, the consumer engages with a menu 12 (see FIG. 1) to select from a plurality of menu options. These can include seasoning preferences, preparation preferences, doneness preferences (i.e., tender, less tender, crispy, soft) and quantity. Each menu option and selection by the consumer can be stored in a memory 502. The menu 12 can be provided as an interactive interface 504 in communication with the point-of-sale system 80 via network 501.

The system 550 includes a controller 560 in operable communication with at least one sensor system 570, at least one alert system 580, and at least one timer system 590. A user 600 can interact with the network 501 and components thereof. The user 600 can include the provider or the consumer. Each of which engages with different system components throughout the preparation process. The point-of-sale system 80 can include a graphical user interface or any other similar system known in the arts.

The controller 560, via the timer system 590, allows the user to adjust a time duration for parboiling, roasting, and deep-frying the ear of corn 1. The controller 560 of the roaster assembly 30 may comprise of a sensor system 570 for sensing the temperature of the gridirons 32 to select a degree of browning of the ear of corn 1, and a selector means for manually adjusting to select a desired set point temperature. The temperatures are adjustable over a range substantially equal to 50° C.-1200° C. Similarly, the controller 560 and sensor system 570 can sense the temperature of the storage components 18, the parboiling reservoirs 24, and the deep-fryer reservoirs 42 to select a degree of completion at each step. Pre-determined times and temperatures can be stored in memory 502 and automatically processed by the system 550.

The sensor system 570 and timer system 590 are in communication with an alert system 580. The memory 502 may store a plurality of threshold values related to the parboiler assemblies 20, roaster assemblies 30, deep-fryer assemblies 40 and storage components 18. Threshold values can include maximum temperatures, minimum temperatures, and maximum time intervals for each component. In one example, the deep-fryer has a minimum threshold temperature of 325° F. and a maximum temperature threshold at 400° F. If these ranges are exceeded, the sensor system 570 sends an alarm signal to the alarm system 580 which in-turn alerts the user 601 via interface 504. Thresholds can be modified via the controller 560. Similarly, the timer system 590 alerts, via the alert system 580, the user 601 upon or near the elapsed time interval at each step.

It is a goal of the present invention to provide the venue as a self-contained and partially mobile system. The venue can be provided having a plurality of sections requiring little to no tools to combine. Further, each section can be provided with wheels for easy transportation. Each preparation component can operate without the need for public water, energy, or gas lines. Such food venue assemblies are well known and readily apparent to one skilled in the art.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification; including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for providing roasted corn comprising:
a. a venue including an interior region including a surface having each of the following; at least one boiling assembly, at least one roasting assembly, at least one storage component, and at least one deep-frying assembly;
b. at least one provider performing the steps of:
i. parboiling an ear of corn;
ii. roasting the ear of corn; and
iii. applying at least one flavor agent to the ear of corn, and providing the ear of corn to a consumer.

2. The system of claim 1, further comprising at least one sink assembly nested atop the surface.

3. The system of claim 2, wherein the sink assembly is comprised of:
a. a water source;
b. a plurality of sink basins;
c. at least one selectively engaged water heater; and
d. at least one water pump configured to pump water from the water source to the plurality of sink basins.

4. The system of claim 3, wherein the water source is in fluid communication with the boiling assembly.

5. The system of claim 1, further including the step of deep-frying the ear of corn following the application of the flavoring agent.

6. The system of claim 5, wherein a batter is applied to the corn before the deep-frying thereof.

7. The system of claim 1, wherein the venue is moveable.

8. The system of claim 1, further comprising a menu affixed to an exterior surface of the venue, wherein the menu is configured to transmit a plurality of options to the consumer, wherein the consumer selects from the plurality of options, and wherein the selection is transmitted to the at least one provider.

9. The system of claim 8, wherein the menu is configured as a point-of-sale system.

10. The system of claim 1, further comprising a network of timers, wherein the network of timers monitors the steps of boiling the ear of corn, roasting the ear of corn, and frying the ear of corn.

11. The system of claim 1, further comprising a network of temperature sensors, wherein the temperature sensors monitor the temperature of the at least one storage component, the at least one boiling assembly, the at least one roasting assembly, and the at least one frying assembly.

12. The system of claim 11, including an alert system coupled to the network of timers and the network of temperature sensors, wherein the alert system is configured to alert the at least one provider at predetermined time intervals associated with the monitored steps.

13. A system for providing roasted corn comprising:
a. a self-contained venue including each of the following preparation components; at least one boiling assembly, at least one roasting assembly, at least one storage component, and at least one frying assembly;
b. a computer system including a menu providing a plurality of selectable options to a consumer, the menu in communication with a point-of-sale terminal;
c. a controller in communication with each of the following: a sensor system, a timer system, and an alert system, wherein the sensor system, the timer system, and the alert system are in communication with the preparation components; and
d. at least one user performing, dependent on the consumer input to the menu, the steps of:
i. parboiling an ear of corn, using the at least one boiling assembly;
ii. roasting the ear of corn, using the at least one roasting assembly; and
iii. applying at least one flavor agent to the ear of corn, and providing the ear of corn to the consumer.

14. The system of claim 13, wherein following the application of at least one flavor agent, the at least one user performs the steps of:
a. applying a batter to the ear of corn; and
b. deep-frying the ear of corn, using the at least one deep-frying assembly.

15. The system of claim 13 further comprising:
a. at least one sink assembly having a water pump configured to transmit water from a water tank to at least one sink basin;
b. a water heater disposed between and in fluid communication with the fresh water tank and the water pump; and
c. a grey water tank in fluid communication with each of the at least one sink basins.

16. The system of claim 13, including an interface coupled to a controller, the controller providing a plurality of pre-determined temperature settings, timer settings, and alert settings, wherein the interface permits transmission of the temperature settings, the timer settings, and the alert settings to a memory;

17. The system of claim 13, further comprising a network of temperature sensors in communication with the alert system, wherein the temperature sensors monitor the temperature of the at least one storage component, the at least one boiling assembly, the at least one roasting assembly, and the at least one frying assembly.

18. The system of claim 13, wherein the alert system is configured to alert the at least one user at predetermined time intervals associated with each of the steps.

19. The system of claim 13, wherein the venue is moveable.

20. The system of claim 13, wherein the at least one flavoring agent is a fluid mixture or a solid.
